(19) United States
(12) Patent Application Publication
(10) Pub. No.: US 2005/0273226 A1
(43) Pub. Date: Dec. 8, 2005

(54) Self-propelled cleaner

(75) Inventor: Takao Tani, Osaka (JP)

Correspondence Address: YOKOI & CO. U.S.A., INC., 13700 MARINA POINTE DRIVE, # 1512, MARINA DEL RAY, CA, 90292, US

(73) Assignee: Funai Electric Co., Ltd., Osaka (JP)

(21) Appl. No.: 11/106,895

(22) Filed: Apr. 14, 2005

(30) Foreign Application Priority Data
Apr. 16, 2004 (JP) JP2004-121542

(51) Int. Cl. G05D 1/00; G01C 22/00

(52) U.S. Cl. 701/23; 701/28

(57) ABSTRACT

With the conventional arts, a self-propelled cleaner can travel along a predetermined travel route but cannot guide and/or inform the occupant for evacuation. The present invention allows a self-propelled cleaner to generate geographical information while traveling in the room, using the detection results of passive sensors for AF and the like, and when a fire is detected by a smoke sensor and/or a temperature sensor, travel to a predetermined guided occupant calling position with the highest priority, shout a guidance messages there, and guide the occupant to a evacuation gate along an evacuation route. It is possible to set a plurality of guided occupant calling positions with priority assigned to each position, and move the self-propelled cleaner to the next guided occupant calling position if there is no response at the first guided occupant calling position.

### BACKGROUND OF THE INVENTION

1. Field of Invention

The present invention relates to a self-propelled cleaner comprising a body equipped with a cleaning mechanism and a drive mechanism capable of steering and driving said self-propelled cleaner.

2. Description of the Invention

Conventionally, there is known a self-propelled cleaning robot, such as one that searches a predetermined route and travels on it (refer to the Japanese Patent Laid-Open No. 2002-366228) or one capable of displaying certain messages (refer to the Japanese Patent Laid-Open No. 2003-290102).

The foregoing conventional self-propelled cleaners can search a predetermined travel route and travel on it, but cannot alert and/or guide the occupant for evacuation.

### SUMMARY OF THE INVENTION

The present invention has been made in view of the above problem and is intended to provide a self-propelled cleaner capable of guiding the occupant in case of a fire, as well as cleaning.

One embodiment of the present invention resides in a self-propelled cleaner having a body equipped with a cleaning mechanism and a drive mechanism capable of steering and driving said self-propelled cleaner, and comprising: a mapping processor that stores geographical information on a room to be cleaned; a guidance processor that allows setting of a guided occupant calling position and an evacuation gate in said geographical information, and also outputting a travel route to both of these locations; a fire detector capable of detecting a fire in said room; a communicator to inform the occupant of information about guidance as an alert; and a guiding travel control processor that, when a fire is detected by said fire detector, causes said communicator to alert the occupant, and at the same time causes said self-propelled cleaner to travel from said guided occupant calling position to said evacuation gate, according to a travel route acquired from said guidance processor.

In the embodiment of the present invention implemented as above, when said fire detector detects a fire in a room, said guidance processor outputs a travel route from the guided occupant calling position to the evacuation gate, which is set in the geographical information, based on said geographical information stored in said mapping processor, and then said guiding travel control processor causes the self-propelled cleaner to alert the occupant, and at the same time to travel from the guided occupant calling position to the evacuation gate according to the travel route acquired from said guidance processor.

That is, said self-propelled cleaner normally travels and cleans a room by itself by means of the drive mechanism capable of steering and driving the self-propelled cleaner, but in case of a fire, detects said fire and travels from the guided occupant calling position, which is previously stored in the geographical information, to the evacuation gate in order to guide the occupant in the room, while raising an alarm. This allows the self-propelled cleaner to inform the occupant in the room of the occurrence of a fire early, and to guide them to the evacuation gate along an evacuation route without fail, even if said evacuation route is not easy to find due to smoke or power failure.

The self-propelled cleaner travels in the room to acquire the geographical information, but it is troublesome to externally and easily provide the information about a particular location. Therefore, said mapping processor may be made to acquire predetermined positional information to be output from a marker which is installed at a specified location in the room, and add that information to the geographical information. The geographical information thus acquired should not be limited into just a room hereinafter. All geographical information to be cleaned in a house or in a building or in a area should be included according to the purpose of the invention.

If the embodiment of the present invention is implemented as described above, said mapping processor acquires said positional information and adds it to the geographical information, by installing the marker that outputs the predetermined positional information, at a specified location where said positional information is acquired for setting it in the geographical information.

For example, installing, at an evacuation gate, a marker that outputs the positional information about the evacuation gate allows the mapping processor to store that location as the evacuation gate, when the self-propelled cleaner arrived at the evacuation gate. Various techniques are conceivable wherein the self-propelled cleaner generates the geographical information, but providing a user interface to allow the user to view and understand the geographical information will require capabilities to display a map, accept the commands entered, and the like, which is costly and troublesome. Moreover, since the self-propelled cleaner is not always traveling at a desired location at a desired time while generating the geographical information, it is not possible to accept a command when the self-propelled cleaner came to the desired position. In contrast, if the marker is installed that provides necessary information, the positional information can be set very easily.

For the positional information, various information can be set, including evacuation gate, guided occupant calling position, room number, and entrance/exit of a room.

When an alarm is raised at the guided occupant calling position, the occupant may or may not notice the alarm immediately. In this case, if a guidance starts too early, the self-propelled cleaner starts a guide travel without guiding the occupant who has not yet noticed the alarm, which is meaningless. On the other hand, when the occupant has already noticed the alarm, if a guidance does not start immediately, evacuation of the occupant may be delayed. To solve this problem, the self-propelled cleaner may be provided with an occupant reaction detector that detects the reaction of the occupant, and said guide travel control processor may be made to start a guidance after the reaction of the occupant is detected by the occupant reaction detector.

If the embodiment of the present invention is implemented as described above, the reaction of the guided occupant detected by the occupant reaction detector is available to said guide travel control processor, and therefore the guide travel control processor can start a guidance after the reaction of the occupant is detected by said occupant reaction detector.

This solves the problem resulting from waiting too long or too short to start a guidance.

As a preferred embodiment of coping with a situation where the reaction of the occupant is not acquired, the self-propelled cleaner may be made to have a plurality of camera devices for taking surrounding images as well as a wireless transmitter to transmit the image data wirelessly to the outside, and said guide travel control processor may be made to take images of the room with said plurality of camera devices and transmit the image data to the outside via said wireless transmitter, when no reaction of the occupant is acquired from said occupant reaction detector.

In the embodiment described above, if said guide travel control processor cannot acquire a reaction of the occupant from the occupant reaction detector, it takes surrounding images and transmits the image data to the outside.

This allows the images around the guided occupant calling position to be externally confirmed, thus making it possible to determine whether or not the guided occupant is there.

Even if the guided occupant is not there, the occupant may be in another room looking for the evacuation gate. Therefore, said guide travel control processor may be made to travel to the evacuation gate if no reaction of the occupant is acquired from said occupant reaction detector, and inform the occupant of the location of the evacuation gate there.

In the embodiment described above, if no reaction of the occupant is acquired at the guided occupant calling position, the self-propelled cleaner travels to the evacuation gate in advance and raises an alarm. This allows the occupant in another room or the like to evacuate without guidance, relying on the alarm from the self-propelled cleaner.

The guided occupant calling position is not necessarily limited to one. Said guidance processor stores a plurality of said guided occupant calling positions with priorities assigned, and said guide travel control processor moves the self-propelled cleaner to a guided occupant calling position with second priority in order to inform the location of the evacuation gate, if no reaction of the occupant is acquired from said occupant reaction detector.

If a plurality of guided occupant calling positions are designated, with priorities assigned in descending order at occupant's convenience, the self-propelled cleaner travels first to a guided occupant calling position with top priority and then to the next, and so on, thus allowing the guided occupant to be guided without fail, as long as the occupant waits for a while at one of the plurality of guided occupant calling positions.

Since there might be a fire on the evacuation travel route, said guidance processor may be made to pinpoint the fire location, when said fire detector detected a fire, by locating the detected fire by consulting the geographical information stored in said mapping processor, and to output a travel route from the guided occupant calling position to the evacuation gate, while circumventing said fire location.

In the foregoing embodiment, the evacuation travel route that circumvents said fire location is determined based on the geographical information and the location of the fire. That is, the fire location is determined by locating the detected fire by consulting the geographical information stored in said mapping processor, when said fire detector detected fire. This makes it possible for the self-propelled cleaner to guide the occupant from the guided occupant calling position to the evacuation gate while circumventing said location of fire.

For the cleaning mechanism provided in the body, it is possible to employ a cleaning mechanism of suction type, brush type that sweeps together dust with a brush, or combination type of those.

With the drive mechanism capable of steering and driving the self-propelled cleaner, it is possible to move the self-propelled cleaner forward/backward, turn right/left, and turn at the same position, by individually controlling the number of rotations of drive wheels disposed at both sides of the body. Needless to say, in this case, auxiliary wheels may be provided, for example, before and behind the drive wheels. Furthermore, the drive wheel may be made to drive an endless belt instead of wheels. Needless to say, the drive mechanism can also be implemented with four wheels, six wheels, etc.

As a more specific embodiment based on the foregoing embodiments, it is possible to provide a self-propelled cleaner having a body equipped with a cleaning mechanism and a drive mechanism having drive wheels, which are disposed on both sides of the body and can be individually controlled to steer and drive the self-propelled cleaner. Said self-propelled cleaner comprises; a mapping processor that acquires and stores geographical information about a room being cleaned while the self-propelled cleaner is traveling around the room, and also acquires predetermined positional information from a marker, which is installed at a specified location in the room to output said predetermined positional information, and adds this information to said geographical information; a fire detector capable of detecting a fire in said room; a guidance processor that makes it possible to set a plurality of guided occupant calling positions with priorities assigned and an evacuation gate in said geographical information, pinpoint the fire location when said fire detector detected a fire, by consulting the geographical information stored in said mapping processor, and output a travel route from said guided occupant calling position to the evacuation gate that circumvents said fire location; a communicator to provides the occupant with the information about guidance as an alarm; an occupant reaction detector to acquire an reaction of the occupant; and a guide travel control processor that, when said fire detector detected a fire, moves the self-propelled cleaner to said guided occupant calling position to inform the occupant of the fire with said communicator, and if no reaction is acquired from said occupant reaction detector while moving the self-propelled cleaner from said guided occupant calling position to the evacuation gate along the travel route acquired from said guidance processor, redirect the self-propelled cleaner to the next guided occupant calling position.

In the embodiment described above, the mapping processor can acquire and store the geographical information on the room while the self-propelled cleaner is traveling around the room for cleaning, and at the same time acquire predetermined positional information outputted from the marker, which is installed at a specified location in the room and outputs said predetermined positional information, and add that information to said geographical information. Furthermore, the guidance processor allows setting of a plurality of guided occupant calling positions with priorities assigned as well as an evacuation gate in said geographical information, pinpointing the location of a fire, when said fire detector detected a fire by consulting the geographical information stored in said mapping processor, and outputting a travel route from said guided occupant calling position to the evacuation gate while circumventing said location of the fire. The guide travel control processor moves the self-propelled cleaner from said guided occupant calling position to the evacuation gate along the travel route acquired from said guidance processor while causing said communicator to call the occupant at said guided occupant calling position, upon detection of a fire by said fire detector. If no reaction of the occupant is not available from said occupant reaction detector at said guided occupant calling position, the guide travel control processor redirects the self-propelled cleaner to a guided occupant calling position with the second priority, and then causes said communicator to call the occupant.

Thus, the present invention takes advantage of the self-propelling capability to allow the occupant to be guided to the evacuation gate without fail in case of emergency, without a lot of additional components.

### BRIEF DESCRIPTION OF THE DRAWINGS

FIG. 1 is a block diagram showing the schematic construction of a self-propelled cleaner according to the embodiment of the present invention.

FIG. 2 is a more detailed block diagram of said self-propelled cleaner.

FIG. 3 is a block diagram of a passive sensor for AF.

FIG. 4 is an explanatory diagram showing the position of a floor relative to the passive sensor and how ranging distance changes when the passive sensor for AF is oriented obliquely toward the floor.

FIG. 5 is an explanatory diagram showing the ranging distance for imaging range when a passive sensor for AF for adjacent area is oriented obliquely toward a floor.

FIG. 6 is a diagram showing the positions and ranging distances of individual passive sensors for AF.

FIG. 7 is a flowchart showing a travel control.

FIG. 8 is a flowchart showing a cleaning travel.

FIG. 9 is a diagram showing a travel route in a room.

FIG. 10 is a diagram showing the construction of an optional unit.

FIG. 11 is a diagram showing the external appearance of a marker.

FIG. 12 is a flowchart showing a mapping processing.

FIG. 13 is a diagram illustrating a mapping.

FIG. 14 is a diagram illustrating how the geographical information on each room is linked together after mapping.

FIG. 15 is a flowchart showing an occupant guiding processing in case of fire.

FIG. 16 is a plan view of a room showing a guide route.

### DESCRIPTION OF THE PREFERRED EMBODIMENTS

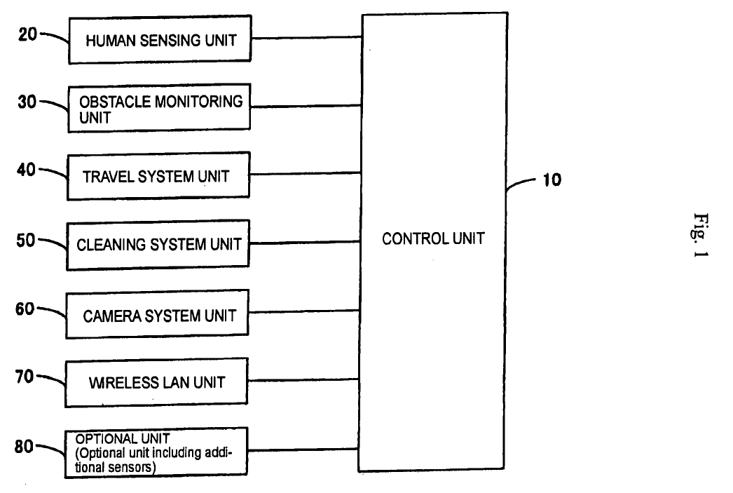

FIG. 1 is a block diagram showing the schematic construction of a self-propelled cleaner according to the present invention. As shown in the figure, the self-propelled cleaner comprises a control unit 10 to control individual units; a human sensing unit 20 to detect a human or humans around the self-propelled cleaner; an obstacle detecting unit 30 to detect an obstacle or obstacles around the self-propelled cleaner; a traveling system unit 40 for traveling; a cleaning system unit 50 to perform a cleaning job; a camera system unit 60 to take images within a predetermined range; a wireless LAN unit 70 for wireless connection to a LAN; and an optional unit 80 including additional sensors and the like. The body of the self-propelled cleaner has a flat rough cylindrical shape.

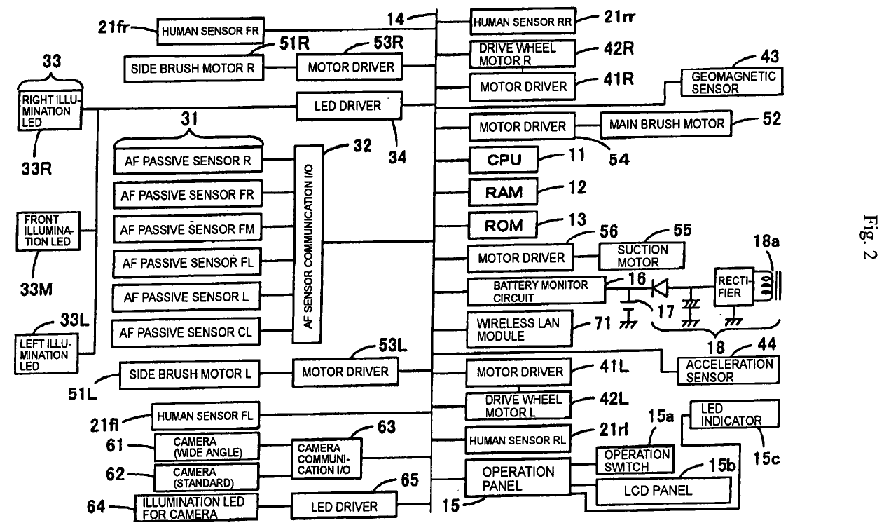

FIG. 2 is a block diagram showing the construction of an electric system that realizes the individual units concretely. A CPU 11, a ROM 13, and a RAM 12 are interconnected via a bus 14 to form the control unit 10. The CPU 11 performs various controls using the RAM 12 as a work area according to a control program stored in the ROM 13 and various parameter tables. The contents of said control program will be described later in detail.

The bus 14 is equipped with an operation panel 15 on which various types of operation switches 15a, an LED display panel 15b, and LED indicators 15c are provided. Although a monochrome LED panel capable of multi-tone display is used for the LED display panel, a color LED panel or the like can also be used.

This self-propelled cleaner has a battery 17, and allows the CPU 11 to monitor the remaining amount of the battery 17 through a battery monitor circuit 16. Said battery 17 is equipped with a charge circuit 18 that charges the battery with an electric power supplied non-contact through an induction coil 18a. The battery monitor circuit 16 mainly monitors the voltage of the battery 17 to detect its remaining amount.

The human sensing unit 20 consists of four human sensors 21 (21fr, 21rr, 21f1, 21r1), two of which are disposed obliquely on both sides of the front of the body and the other two on both sides of the rear of the body. Each human sensor 21 has a light-receiving sensor that detects the presence of a human based on the change in the amount of infrared light received. In order to change the status to be output when the human sensor detects an object with an emitted infrared light changing, the CPU 11 can obtain detection status of the human sensor 21 via the bus 14. That is, it is possible for the CPU 11 to obtain the status of each of the human sensors 21fr, 21rr, 21f1, and 21r1 at predetermined intervals, and detect the presence of a human in front of the human sensor 21fr, 21rr, 21f1, or 21r1 if the status changes.

Although the human sensor described above detects the presence of a human based on changes in the amount of infrared light, an embodiment of the human sensor is not limited to this. For example, if the CPU's processing capability is increased, it is possible to take a color image of the room to identify a skin-colored area that is characteristic of a human, and detect the presence of a human based on the size of the area and/or changes in the area.

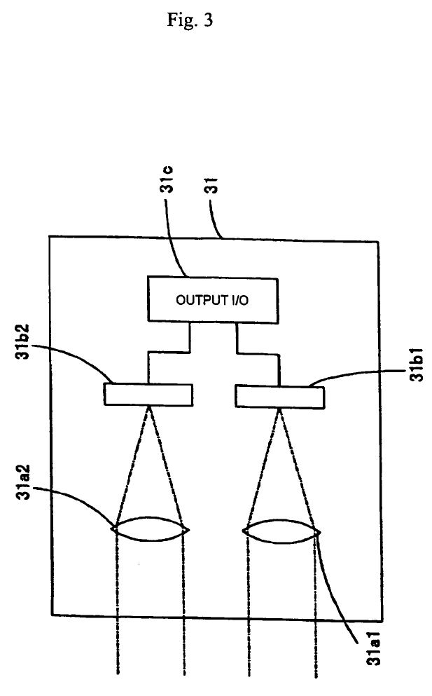

The obstacle monitoring unit 30 comprises the passive sensor 31 (31R, 31FR, 31FM, 31FL, 31L, 31CL) as a ranging sensor for auto focus (hereinafter, called AF); an AF sensor communications I/O 32 which is a communication interface to the passive sensor 31; an illumination LED 33; and an LED driver 34 to supply a driving current to each LED. First, the construction of the passive sensor for AF 31 will be described. FIG. 3 shows a schematic construction of the passive sensor for AF 31 comprising almost parallel biaxial optical systems 31a1, 31a2; CCD line sensors 31b1, 31b2 disposed approximately at the image focus locations of said optical systems 31a1 and 31a2 respectively; and an output I/O 31c to output image data taken by each of the CCD line sensors 31b1 and 31b2 to the outside.

The CCD line sensors 31b1, 31b2 each have a CCD sensor with 160 to 170 pixels and can output 8-bit data representing the amount of light for each pixel. Since the optical system is biaxial, formed images are misaligned according to the distances, which enables the distance to be measured based on a disagreement between data output from respective CCD line sensors 31b1 and 31b2. For example, the shorter the distance the larger the misalignment of formed images and vice versa. Therefore, an actual distance is determined by scanning data row for every four to five pixels in output data, finding a difference between the address of an original data row and that of a discovered data row, and then referencing a “difference to distance conversion table” prepared in advance.

Out of the passive sensors for AF, 31R, 31FR, 31FM, 31FL, 31L, 31CL, the 31FR, 31FM, 31FL are used to detect an obstacle located straight ahead of the self-propelled cleaner, the 31R, 31L are for detecting an obstacle located immediately ahead of the left or right side of the self-propelled cleaner, and the 31CL is for detecting a distance to the forward ceiling.

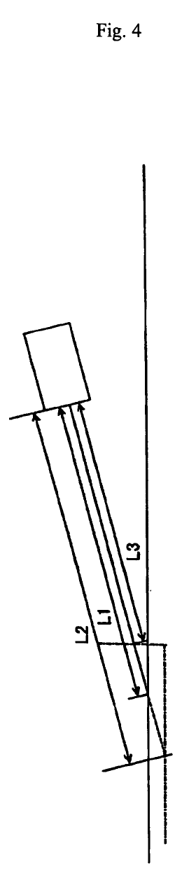

FIG. 4 shows the principle of detecting an obstacle located straight ahead of the self-propelled cleaner or immediately ahead of the left or right side of the self-propelled cleaner, by means of the passive sensors for AF 31. These passive sensors are mounted obliquely toward a forward floor. If there is no obstacle ahead, ranging distance of the passive sensor for AF 31 is L1 in almost whole image pick-up range. However, if there is a step as shown with a dotted line in the Figure, ranging distance becomes L2. Thus, extended ranging distance means that there is a downward step. Likewise, if there is an upward step as shown with a double-dashed line, ranging distance becomes L3. Ranging distance when an obstacle exists also becomes a distance to the obstacle as in the case of an upward step, and thus becomes shorter than the distance to the floor.

In this embodiment, if the passive sensor for AF 31 is mounted obliquely toward a forward floor, its image pick-up range becomes about 10 cm. Since the self-propelled cleaner is 30 cm in width, three passive sensors for AF, 31FR, 31FM, 31FL are mounted at slightly different angles from each other so that their image pick-up ranges will not overlap. This allows the three passive sensors for AF to detect any obstacle or step within a forward 30 cm range. Needless to say, detection range varies with the specification and/or mounting position of a sensor, in which case the number of sensors meeting actual detection range requirements may be used.

The passive sensors for AF, 31R, 31L which detect an obstacle located immediately ahead of the right and left sides of the self-propelled cleaner are mounted obliquely toward a floor relative to vertical direction. The passive sensor for AF 31R disposed at the left side of the body faces opposite direction so as to pick up an image of the area immediately ahead of the right side of the body and to the right across the body. The passive sensor for AF 31L disposed at the right side of the body also faces the opposite direction so as to pick up an image of the area immediately ahead of the left side of the body and to the left across the body.

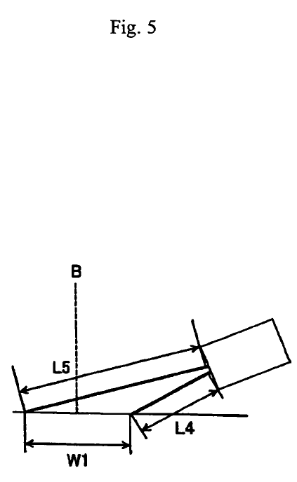

If said two sensors are disposed without crossing so that each sensor picks up an image of the area immediately ahead of the sensor, the sensor must be mounted so as to face a floor at a steep angle and consequently the image pick-up range becomes narrower, thus making it necessary to provide multiple sensors. To prevent this, the sensors are intentionally disposed cross-directionally to widen the image pick-up range, so that required range can be covered by as few sensors as possible. Meanwhile, mounting the sensor obliquely toward a floor relative to the vertical direction means that the arrangement of CCD line sensors is vertically directed and thus the width of an image pick-up range becomes W1 as shown in FIG. 5. Here, distance to the floor is short (L4) on the right of the image pick-up range and long (L5) on the left. If the border line of the side of the body is at the position of the dotted line B, an image pick-up range up to the border line is used for detecting a step or the like, and an image pick-up range beyond the border line is used for detecting a wall.

The passive sensor for AF 31CL to detect a distance to a forward ceiling faces the ceiling. The distance between the floor and ceiling to be detected by the passive sensor 31CL is normally constant. However, as the self-propelled cleaner approaches a wall, the wall, instead of the ceiling, enters in the image pick-up range and consequently the ranging distance becomes shorter, thus allowing a more precise detection of a forward wall.

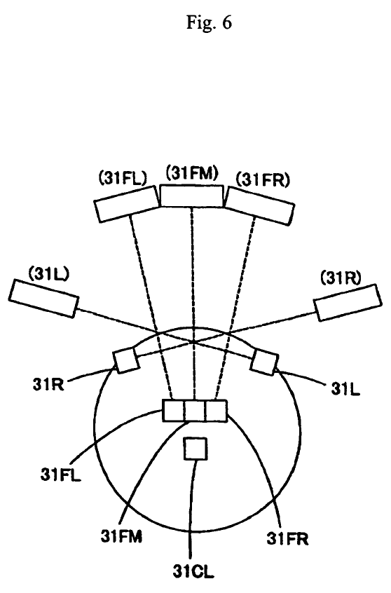

FIG. 6 shows the positions of the passive sensors for AF, 31R, 31FR, 31FM, 31FL, 31L, 31CL mounted on the body, and their corresponding image pick-up ranges in parentheses. The image pick-up ranges for a ceiling are not shown.

A right illumination LED 33R, a left illumination LED 33L, and a front LED 33M, all of which are white LED, are provided to illuminate the image pick-up ranges of the passive sensors for AF, 31R, 31FR, 31FM, 31FL, 31L. An LED driver 34 supplies a drive current to turn on these LEDs according to a control command from the CPU 11. This allows obtaining effective pick-up image data from the passive sensors for AF 31 even at night or at a dark place such as under a table.

The travel system unit 40 comprises motor drivers 41R, 41L; drive wheel motors 42R, 42L; and a gear unit (not shown) and drive wheels, both of which are driven by the drive wheel motors 42R, 42L. The drive wheel is disposed at both sides of the body, one at each side, and a free-rotating wheel without a driving source is disposed at the front center of the bottom of the body. The rotation direction and rotation angle of the drive wheel motors 42R, 42L can be finely regulated by the motor drivers 41R, 41L respectively, and each of the motor drivers 41R, 41L outputs a corresponding drive signal according to a control command from the CPU 11. Furthermore, the rotation direction and rotation angle of actual drive wheels can be precisely detected, based on the output from a rotary encoder mounted integrally with the drive motors 42R, 42L. Also, it is possible to dispose free-rotating driven wheels near the drive wheels, instead of directly coupling the rotary encoder to the drive wheels, and feedback the amount of rotation of said driven wheels. This enables actual amount of the drive wheels to be detected even when the drive wheels is skidding. The travel system unit 40 further comprises a geomagnetic sensor 43 that enables travel direction to be determined according to geomagnetism. An acceleration sensor 44 detects accelerations in three axis (X, Y, Z) directions and outputs detection results.

Various types of gear unit and drive wheels can be adopted, including a drive wheel made of a circular rubber tire and an endless belt.

The cleaning mechanism of this self-propelled cleaner comprises side brushes disposed at both sides of the front of the self-propelled cleaner that sweeps together dust, etc. on the floor around both sides of the body, a main brush that scoops up the dust collected around the center of the body, and a suction fan that sucks in the dust swept together by said main brush at around the center of the body, and feed the dust to a dust box. The cleaning system unit 50 comprises side brush motors 51R, 51L and a main brush motor 52 to drive corresponding brushes; motor drivers 53R, 53L, 54 that supply drive current to the respective brush motors; a suction motor 55 to drive a suction fan; and a motor driver 56 that supplies current to said suction motor. During a cleaning, the side brushes and a main brush are controlled by the CPU 11 based on floor condition, condition of the battery, instruction of the user, etc.

The camera system unit 60 is equipped with two CMOS cameras 61, 62, each with a different visual field angle, which are disposed at the front of the body and set to different elevation angles. The camera system unit further comprises a camera communication I/O 63 that instructs each of the cameras 61, 62 to take an image of a floor ahead and outputs the taken image; an illumination LED for a camera 64 consisting of 15 white LEDs directed toward an image to be taken by the cameras 61, 62; and an LED driver 65 to supply drive current to said LED for illumination.

The wireless LAN unit 70 is equipped with a wireless LAN module 71, and the CPU 11 can be wirelessly connected to an external LAN according to a predetermined protocol. The wireless LAN module 71 assumes the provision of access points (not shown), which allow for connection to external wide area networks, such as the Internet, via routers or the like. This provides for sending and receiving of mails, browsing of WEB sites, etc. The wireless module 71 comprises a standardized card slot, a standardized wireless LAN card to be connected to said card slot, and the like. Needless to say, other standardized cards can also be connected to the card slot.

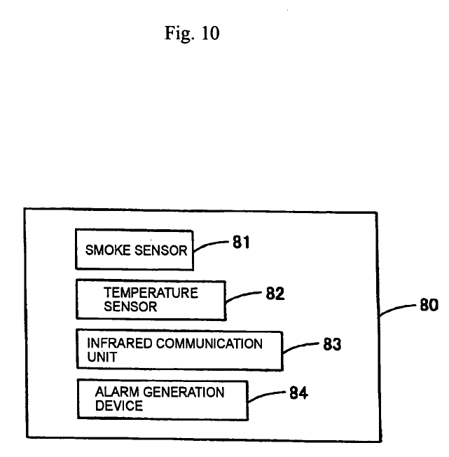

The optional unit 80 comprises additional sensors, etc. as shown in FIG. 10. In this embodiment, the optional unit contains a smoke sensor 81, a temperature sensor 82, an infrared communication unit 83, and an alarm generation device 84. The smoke sensor 81 is a sensor to detect smoke and the temperature sensor 82 is for detecting temperatures, each sensors being connected to said bus 14. Said CPU 11 can acquire the detection status of each sensor. The infrared communication unit 83 can receive an infrared signal, which is coded positional information to be sent from a marker described below, and decode said positional information to transmit to the CPU 11. The alarm generation device 84 can generate an alarm as a voice to prompt evacuation in case of fire. Voice is preferable, but siren or buzzer may serve the purpose.

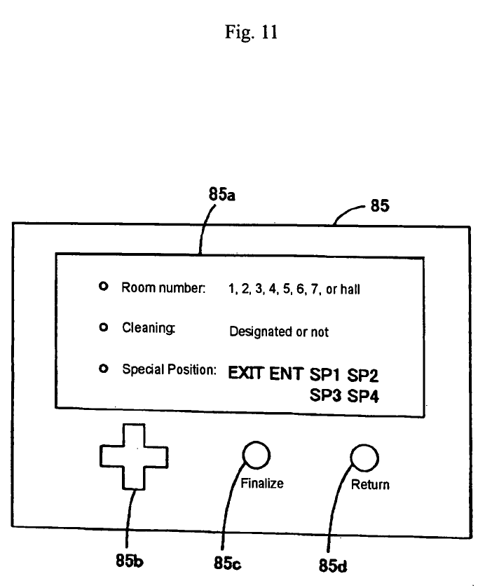

FIG. 11 shows an external appearance of said marker 85, on which an LED display 85a, a cross key 85b, a Finalize key 85c, and a Return key 85d are provided. Said marker 85 includes a single-chip microcomputer, an infrared communication unit, and a battery. The single-chip microcomputer is capable of controlling the display on the LED display panel 85a according to the operations of the Finalize and Return keys, generating setting parameters according to said operations, and outputting positional information corresponding to said setting parameters from said infrared communication unit. In this embodiment, it is possible to set Room number: “1 to 7 and hall”, whether or not to clean: “Yes” “No”, and Special designation: “EXIT(exit)”, “ENT (entrance)”, “SP1(special position 1)”, “SP2(special position 2)”, “SP3(special position 3)”, “SP4(special position 4). In the following embodiment, the special position 1 is the guided occupant calling position, the special position 2 is the evacuation gate, the special position 3 is the start of a security travel route, and the special position 4 is the end of the security travel route. A flowchart required for these settings is not a special one but can be prepared by one skilled in the art with ordinary knowledge.

Now, the operation of the self-propelled cleaner embodied as above will be described.

(1) Travel Control and Cleaning Operation

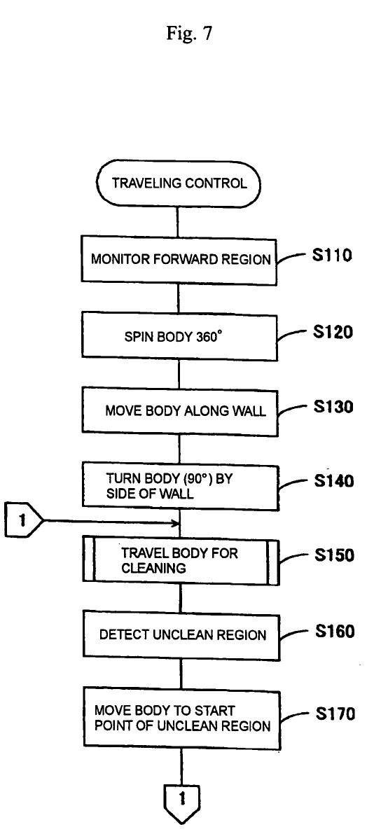

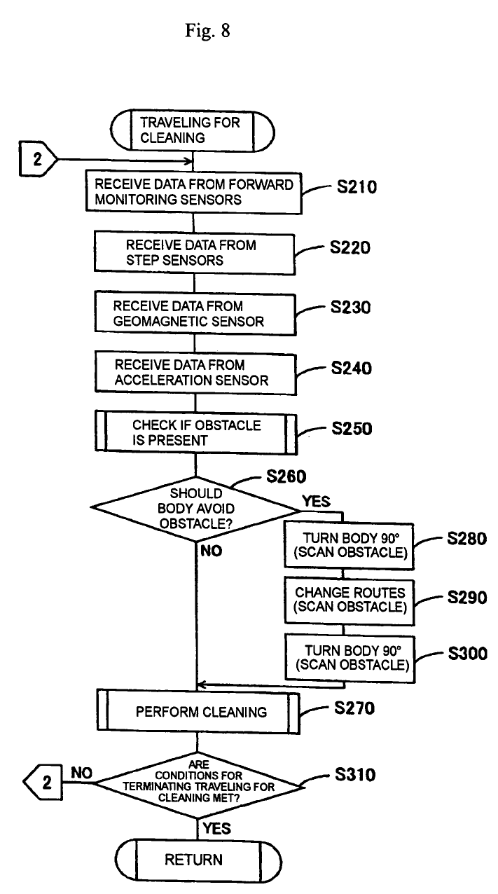

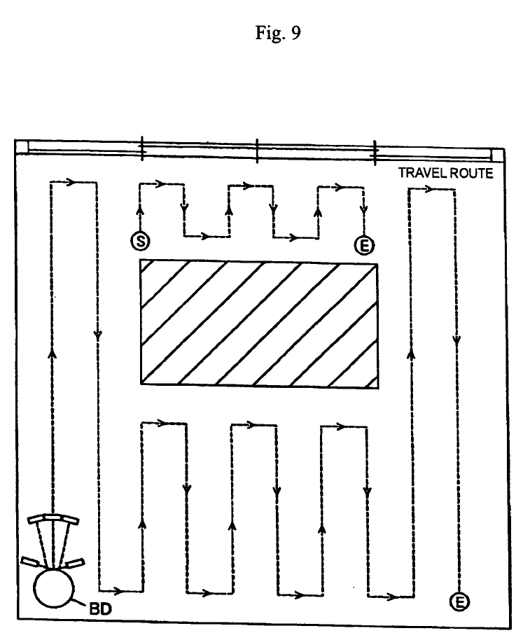

FIG. 7 and FIG. 8 show flowcharts corresponding to the control programs said CPU 11 executes and FIG. 9 shows a route along which the self-propelled cleaner travels according to said control programs.

When the power is turned on, the CPU 11 starts the travel control shown in FIG. 7. In step S110, detection results of the passive sensor for AF 31 are input for monitoring a front area. The detection results of the passive sensors for AF, 31FR, 31FM, 31FL are used for monitoring a front area. If the area is flat, “the distance to an obliquely down area of the floor, L1” can be obtained from the taken image (detection results). Based on the detection results of the individual passive sensors for AF, 31FR, 31FM, 31FL, it can be determined whether or not the front floor as wide as the body is flat. At this point, however, no information has been obtained about an area from the floor each of the passive sensors for AF, 31FR, 31FM, 31FL is facing to that immediately before the body, and consequently that area becomes a blind spot.

In step S120, the CPU 11 commands the motor drivers 41R, 41L to drive the drive wheel motors 42R, 42L respectively, so as to rotate the drive wheel motors in a different direction from each other, but at the same number of rotation. As a result, the body starts to turn around at the same position. Since the number of rotation of the drive motors 42R, 42L required for a 360 degree spin turn at the same position is already known, the CPU 11 commands the motor drivers 41R, 41L to rotate the drive wheel motors at that number of rotation.

During a spin turn, the CPU 11 inputs detection results of the passive sensors for AF, 31R, 31L to determine the status of the floor immediately before the body. Said blind spot is almost eliminated by the detection results obtained during this period, and the flat floor around the body can be detected if there is no step or obstacle.

In step S130, the CPU 11 commands the motor drivers 41R, 41L to rotate the respective drive wheel motors 42R, 42L at the same number of rotation. As a result, the body starts to move strait ahead. During moving straight ahead, the CPU 11 inputs detection results of the passive sensors for AF, 31FR, 31FM, 31FL to move ahead the self-propelled cleaner while determining whether or not any obstacle exists ahead. If a wall (an obstacle) is detected ahead of the self-propelled cleaner, from said detection results, the self-propelled cleaner stops at a predetermined distance from the wall.

In step S140, the body turns to the right 90 degrees. The body stops at a predetermined distance from the wall in step S130. This predetermined distance is a distance within which the body can turn without colliding against the wall, and also a range outside the width of the body detected by the passive sensors for AF, 31R, 31L which are used to determine the situations immediately before and to the right and left sides of the body. That is, in step S130, the body stops based on detection results of the passive sensors for AF, 31FR, 31FM, 31FL, and when turning 90 degrees in step S140, the body stops at a distance within which at least the passive sensor for AF 31L can detect the position of the wall. When turning 90 degrees, the situation immediately ahead of the body is determined beforehand based on detection results of said passive sensors for AF, 31R, 31L. FIG. 9 shows a situation where a cleaning is started at the lower left corner of a room (cleaning start position) where the self-propelled cleaner reached in this way.

There are various methods of reaching the cleaning start position other than the one mentioned above. For example, only turning right 90 degrees when the self-propelled cleaner reached a wall may result in a cleaning being started at the middle of the first wall. Therefore, in order to reach an optimum start position at the lower left corner of the room as shown in FIG. 9, it is desirable for the self-propelled cleaner to turn left 90 degrees when it comes up against a wall, then move forward to the front wall, and turn 180 degrees when the self-propelled cleaner reaches the wall.

In step S150, a cleaning travel is performed. FIG. 8 shows a more detailed flow of said cleaning travel. Before traveling forward, detection results of various sensors are input in steps S210 to S240. Step S210 inputs data from the forward monitoring sensors, specifically, detection results of the passive sensors for AF, 31FR, 31FM, 31FL, 31CL, which are used to determine whether or not an obstacle or wall exists ahead of the traveling range. The forward monitoring includes the monitoring of the ceiling in a broad sense.

Step S220 inputs the data from step sensors, specifically, detection results of the passive sensors for AF, 31R, 31L, which are used to determine whether or not there is a step immediately before the traveling range. When traveling along a wall or obstacle in parallel, a distance to the wall or obstacle is measured and the data thus obtained is used to determine whether or not the self-propelled cleaner is moving in parallel to the wall or obstacle.

Step S230 inputs data from a geomagnetic sensor, specifically the geomagnetic sensor 43, which is used to determine whether or not travel direction varies during a forward travel. For example, an angle of geomagnetism at the start of a cleaning travel is stored in memory and if the angle detected during travel differs from the stored angle, then the travel direction is corrected back to the original angle, by slightly changing the number of rotations of either left or right drive wheel motors of 42R, 42L. For example, if travel direction changed toward an angle-increasing direction (except for a change from 359 degree to 0 degree), it is necessary to correct the pass toward left direction by issuing a drive control command to the motor driver 41R, 41L to increase the number of rotations of the right drive wheel motor 42R slightly more than that of the left drive wheel motor 42L.

Step S240 inputs data from an acceleration sensor, specifically detection results of the acceleration sensor 44, which is used to check for travel condition. For example, if an acceleration toward a roughly constant direction can be detected at the start of a forward travel, it is determined that the self-propelled cleaner is traveling normally. However, if a rotating acceleration is detected, it is determined that either drive wheel motor is not driven. Also, if an acceleration exceeding a normal range of vales, it is determined that the self-propelled cleaner fell from a step or overturned. If a large backward acceleration is detected during a forward travel, it is determined that the self-propelled cleaner hit an obstacle located ahead. Although direct control of the travel, such as maintaining a target acceleration by inputting an acceleration value, or determining the speed of the self-propelled cleaner based on the integral value, is not performed, acceleration values are effectively used to detect abnormalities.

Step S250 determines whether an obstacle exists, based on detection results of the passive sensors for AF, 31FR, 31FM, 31CL, 31FL, 31R, 31L, which have been input in steps S210 and S220. The determination of an obstacle is made for the front, the ceiling, and the area immediately ahead. The front is checked for an obstacle or wall, the area immediately ahead is checked for a step and the situations to the right and left outside the traveling range, such as existence of a wall. The ceiling is checked for an exit of the room without a door by detecting a head jamb or the like.

Step S260 determines whether or not the self-propelled cleaner need to get around based on detection results of each sensor. If the self-propelled cleaner need not to get around, the cleaning process in step S270 is performed. The cleaning process is a process of sucking in dust on a floor while rotating the side brush and the main brush, specifically, issuing a command to drive the motor drivers 53R, 53L, 54, 56 to drive motors 51R, 51L, 52, 55 respectively. Needless to say, said command is issued at all times during a travel and is stopped when a terminating condition described below is satisfied.

In contrast, if it is determined that getting around is necessary, the self-propelled cleaner turns right 90 degrees in step S280. This turn is a 90 degree turn at the same position, and is caused by instructing the motor drivers 41R, 41L to rotate the drive wheel motors 42R, 42L in different direction from each other and give a driving force to provide the number of rotations required for a 90 degree turn. The right drive wheel is rotated backward and the left drive wheel is rotated forward. While the wheels is rotating, detection results of step sensors, specifically the passive sensors for AF, 31R, 31L, are input to determine whether or not an obstacle exist. For example, when an obstacle is detected in front and the self-propelled cleaner is turned right 90 degrees, if the passive sensor for AF 31R does not detect a wall immediately ahead on the right, it may be determined that the self-propelled cleaner comes near the front wall. However, if the passive sensor detects a wall immediately ahead on the right even after the turn, it may be determined that the self-propelled cleaner is at a corner. If neither of the passive sensors for AF, 31R, 31L detects an obstacle immediately ahead, it may be determined that the self-propelled cleaner comes near not a wall but a small obstacle.

In step S290, the self-propelled cleaner travels forward while scanning obstacles. When the self-propelled cleaner comes near a wall, it turns right 90 degrees and moves forward. If the self-propelled cleaner stops just before the wall, the forward travel distance is about the width of the body. After moving forward by that distance, the self-propelled cleaner makes a 90 degree right turn again in step S300.

During this travel, scanning of obstacles on front right and left sides is performed at all times to identify the situation, and the information thus obtained is stored in the memory.

Meanwhile, a 90 degree right turn is made twice in the above description, and therefore if a 90 degree right turn is made when another wall is detected in front, the self-propelled cleaner returns to the original position. To prevent this, the 90 degree turn is to be made alternately between right and left directions, such as, if the first turn is to the right, the second is to the left, the third is to the right and so on. Accordingly, odd time turns become right turns and even time turns become left turns.

Thus, the self-propelled cleaner travels in a zigzag in the room while scanning obstacles and getting around them. Step S310 determines whether or not the self-propelled cleaner arrived at the terminal position. A cleaning travel terminates either when the self-propelled cleaner traveled along the wall after the second turn and then detected an obstacle, or when the self-propelled cleaner moved into the already traveled area. That is, the former is a terminating condition that occurs after the last end-to-end zigzag travel, and the latter is a terminating condition that occurs when a cleaning travel is started again upon discovery of a not yet cleaned area as described below.

If neither of these terminating conditions is satisfied, the cleaning travel is repeated from step S210. If either terminating condition is satisfied, the subroutine for this cleaning travel is terminated and control returns to the process shown in FIG. 7.

After returning to that process, step S160 determines whether there is any area not yet cleaned, based on the previous travel route and situations around the travel route. If a not-yet cleaned area is found, the self-propelled cleaner moves to the start point in the not-yet cleaned area to resume a cleaning travel from step S150.

Even if several not-yet cleaned areas exist around the floor, it is possible to eliminate those areas eventually by repeating the detection of a not-yet cleaned area whenever the cleaning travel terminating condition mentioned above is satisfied.

(2) Mapping

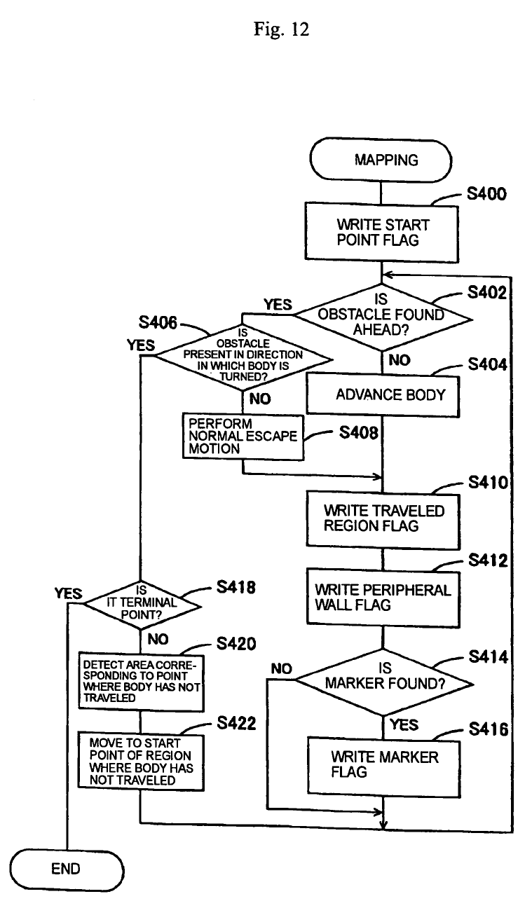

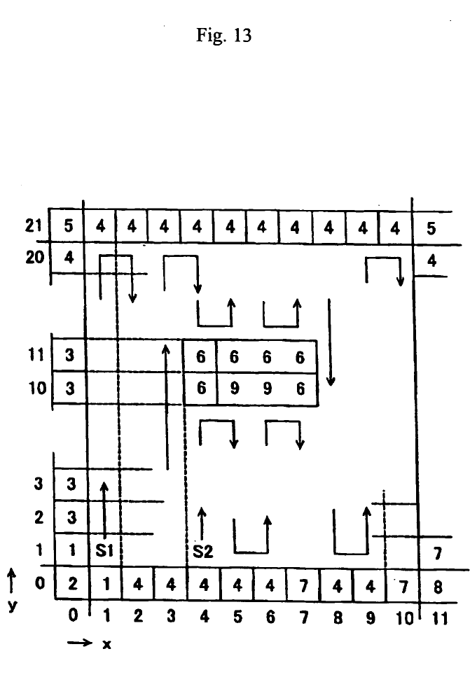

Although not-yet cleaned areas can be identified by various methods, embodied here is the mapping method shown in FIG. 12 and FIG. 13.

FIG. 12 shows a flowchart of the mapping and FIG. 13 is a diagram illustrating the mapping method. In this example, a travel route and walls detected during a travel are written on the map reserved in memory area, based on detection results of said rotary encoder, and it is determined whether or not surrounding walls are continuous, surrounding areas of detected obstacles are also continuous, and the cleaning travel covered all the areas excluding the obstacles.

A mapping database is a two-dimensional database addressable with X and Y axes, the (1, 1) being the start point and the (n, 0) (0m m) representing provisional walls. The room is mapped by marking off not-yet traveled area, cleaning-completed area, wall, and obstacle, using the size of the body (30 cm×30 cm) as unit area.

Step S400 writes a flag of the start point. As shown in FIG. 13, the start point (1, 1) is a corner of the room. The self-propelled cleaner makes a 360 degree spin turn to ensure that walls exist back and left, (1) wall flags are written at respective unit areas (1, 0), (0,1), and (2) a wall flag is also written at the intersection (0, 0). Step S402 determines whether any obstacle exists ahead of the body and if there is no obstacle, the self-propelled cleaner travels forward by unit area in step S404. This forward travel is actually a cleaning travel mentioned above, specifically, when the self-propelled cleaner has traveled by unit area during a cleaning travel, which is determined based on the output from the rotary encoder, the mapping processing is synchronized with the travel of the self-propelled cleaner when it moved by unit area, and continued in parallel with the travel.

In contrast, if an obstacle is identified ahead of the self-propelled cleaner, it is determined whether or not an obstacle exists in the turning direction in step S406. An obstacle is circumvented by turning 90 degrees, traveling forward, and turning 90 degrees again, and the turning direction is changed by repeating a left turn and a right turn twice respectively. For example, if a next turn for circumvention is to the right, when an obstacle exists in front, it will be determined whether or not it is possible to travel in the right direction and turn. Initially, it is determined that the area in the right direction is a not-yet cleaned area and no obstacle exists in the turning direction, and as a result an ordinary circumvention movement is made in step S408.

After these movements, step S410 writes a travel area flag to a unit area of the travel route. Since having traveled means having cleaned, a flag indicating the cleaning-finished area is written on the map. Step S412 writes the situations of surrounding walls as a surrounding wall flag for each unit area. When the self-propelled cleaner moved from the unit area (1, 1) to (1, 2), it is possible to determine whether or not the unit areas (0, 1), (2, 1) are walls, based on detection results of the passive sensors for AF, 31R, 31L. A flag indicating a wall can be written for the unit area (0, 1) and a flag indicating a not-yet traveled and not-yet cleaned area can be written for the unit area (2, 1).

Meanwhile, in the unit area (1, 20), an obstacle is detected in front and therefore the self-propelled cleaner reversed the traveling direction 180 degrees by making a 90 degree turn twice while traveling to the unit area (2, 20). At this time, a flag can be written for each of the unit areas (0, 20), (2, 20), (1, 21), (2, 21)-(4). For the unit area (0, 21), a flag indicating a wall is written, based on the judgment that this unit area is an intersection between walls—(5). An already traveled and cleaned area is also treated as an obstacle.

When the self-propelled cleaner travels forward, an obstacle is detected in the right direction at the unit areas (3, 10) and (3, 11) and an obstacle flag is written at this point—(6). During a travel at unit areas (3, 1) through (3, 9), a not-yet traveled and not-yet cleaned area is detected on the right side of the traveling direction and a flag indicating this area is written. Likewise, when the self-propelled cleaner travels at unit areas (8, 9) through (8, 1), a not-yet traveled and not-yet cleaned area is detected on the right side of the traveling direction and a flag indicating this area is written.

In the unit area (4, 12), an obstacle is detected in front and a circumvention movement is made. At this time, however, an obstacle flag has been written to the unit area (4, 11) and therefore an obstacle flag is written to the unit area (4, 11), as the self-propelled cleaner travels.

Step S414 determines whether or not a communication was made with said marker 85 to obtain positional information at a unit area through which the self-propelled cleaner traveled, and if a communication was made, then a flag based on the information obtained from the marker is written. For example, if the user has placed the self-propelled cleaner at a particular unit area to specify an emergency exit, by operating the operation keys 85b to 85d of the marker 85, the self-propelled cleaner will obtain said positional information by means of the infrared communication unit 83 when the body passes said unit area, and writes a flag indicating an emergency exit.

The self-propelled cleaner repeats a forward travel and a circumvention movement, and detects an obstacle at the unit area (10, 20) on the left side of traveling direction. In this case, since the unit area (10, 21) has been identified as a continuous wall, a flag indicating a wall is written for the unit area (11, 20)-(4), and then a wall flag is also written for the intersection (11, 21)-(5).

As a result of repeating a forward travel and a circumvention movement, the self-propelled cleaner detects an object in front and it is determined that another obstacle exists in a turning direction. In this case, therefore, step S418 determines whether or not this obstacle is the terminating point. For the unit area (10, 1), an obstacle in front and a wall on the left side of the traveling direction are detected—(7), (8).

Whether or not said unit area is the terminating point is determined first by determining whether or not a unit area to which a not-yet traveled and not-yet cleaned flag is written exists. If there are no more unit areas detected to which a not-yet traveled and not-yet cleaned flag is written, it is determined whether or not the wall flag written at the start point is surrounding the room continuously. If this flag is surrounding the room any area to which a flag has not been written is searched for by scanning the room in X and Y directions. An area identified as an obstacle is also identified as a continuous area just like a wall, which completes the detection of obstacles.

If said unit area is not the terminating point, the self-propelled cleaner detects a not-yet traveled area in step S420, moves to the start point at the not-yet traveled area, and repeats the processing mentioned above. If the terminating point is eventually identified the mapping processing is completed. At the completion of the mapping, the walls and travel areas in the room are obvious at a glance. This map is used as geographical information on each room.

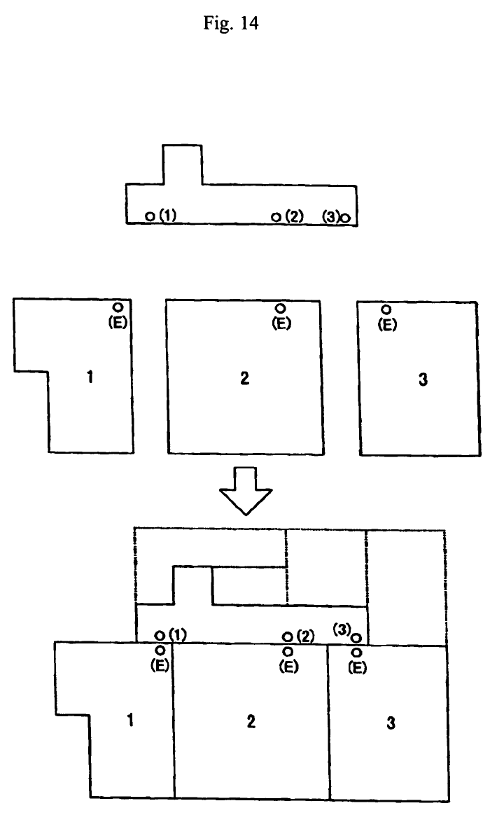

The mapping processing mentioned above is completed for all rooms and a hall. For the hall, the entrance to each room is to be designated by means of the marker 85. FIG. 14 shows a method of linking together the geographical information generated for each room and a hall. By designating the room number (1 to 3) and exit (E) of each room, the entrance to each room, etc., the geographical information obtained for each room can be linked together two-dimensionally.

(3) Guidance in Case of Fire

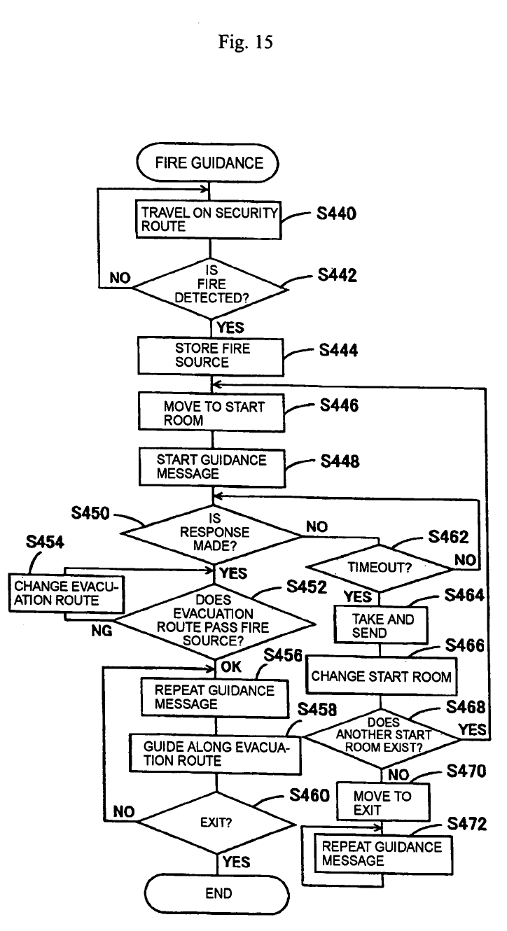

FIG. 15 shows a flowchart of the processing for occupant guidance in case of fire.

When this processing is instructed through the operation panel unit 15, the self-propelled cleaner travels on a security travel route in step S440. The traveling on the security travel route is predetermined by specifying the start position (SP3) and the end position (SP4) with the marker. However, it is possible to stop the self-propelled cleaner to monitor a possible fire source. In step s442, the CPU11 acquires the detection results of the smoke sensor 81 and temperature sensor 82 to determine whether a fire occurs.

The security route travel continues in step S440 unless a fire is detected, but if a fire is detected the detected location is stored as fire source in step S444, and the self-propelled cleaner moves to a start room to start a guidance in step S446. The start room refers to a room designated as guided occupant calling position with the highest priority at that point, when multiple such positions can be set. When only one guided occupant calling position is set, that position becomes the start room. When multiple guided occupant calling positions are set, a room with the highest priority becomes the start room first, and then a room with the second priority, and so on, as described below.

When the self-propelled cleaner has moved to the guided occupant calling position at that point in step S446, it outputs a guidance message to raise an alarm in step S448. In step S450, the self-propelled cleaner waits for a response from the user. To prompt the use to input the response via an operation switch 15a, a message is displayed on a LCD panel 15b. Needless to say, the response may be made by voice instead of using the operation switch 15a.

If no response is made, the self-propelled cleaner determines whether or not a predetermined time period is over and timeout occurs, in step S462, and continues to wait for the response until timeout occurs.

When the response is made, in step S452, the self-propelled cleaner checks if the evacuation route passes the fire source.

As described above, if the geographical information is available, it is possible to search for a travel route from a guided occupant calling position to the evacuation gate. The travel route can be found with the well-known maze problem solution. For example, if you move along amaze from its entrance with your right hand always touching the wall according to such technique, you can reach the goal eventually, then, erase redundant routes, for example, a turned around route, one by one. Since the self-propelled cleaner travels inside a room, finds a location where the cleaner made a horseshoe-shaped turn and shifts such a location away from the wall to shorten the route unless there is an obstacle. Needless to say, it is also possible to provide an interface to give a travel route to the user, instead of automatically finding one as described above.

After a travel route is found in this way, it is determined whether or not the travel route passes the fire source stored in step S444. If the travel route passes the fire source, the evacuation route is changed in step S454, and it is confirmed that the new evaluation route does not pass the fire source, in step S452.

When the evacuation route is decided, the guidance message is repeatedly shouted in step S456, and the occupant is guided along the evacuation route in step S458. The guidance is made until it is determined in step S460 that the occupant has reached an exit designated as evacuation gate.

Meanwhile, timeout may occur while the self-propelled cleaner is waiting for a response from the user in step S450. In this case, an image around there is taken with the camera system unit 60 in step S464 and the image data is transmitted to an external file server or as an E-mail via the wireless LAN unit 70.

Then, in step S466, the start room is changed to another room where the next guided occupant calling station is designated. As mentioned above, if there are a plurality of guided occupant calling positions designated, a change to one with lower priority is made. If another room with lower priority is designated as the start room in step S468, returning to step S446, the above procedure is repeated in the newly-designated start room. In this way, it is possible for the self-propelled cleaner to travel from one guided occupant calling position to another in order of priority set for multiple guided occupant calling positions, and raise an alarm to guide the occupant, as long as there is a response.

If there is no response from the occupant even if the priority is lowered, then move the self-propelled cleaner to the exit (evacuation gate) in step S470 and cause it to shout the guidance message repeatedly at the evacuation gate in step S472. Also, there is a possibility that the guided occupant noticed the fire and started evacuation, but cannot find a way out due to smoke. In such a case, even if the self-propelled cleaner moved to the guided occupant calling position, the occupant would not be there, and therefore cause the self-propelled cleaner to shout the guidance message repeatedly at the evacuation gate to inform the stray occupant of the exit.

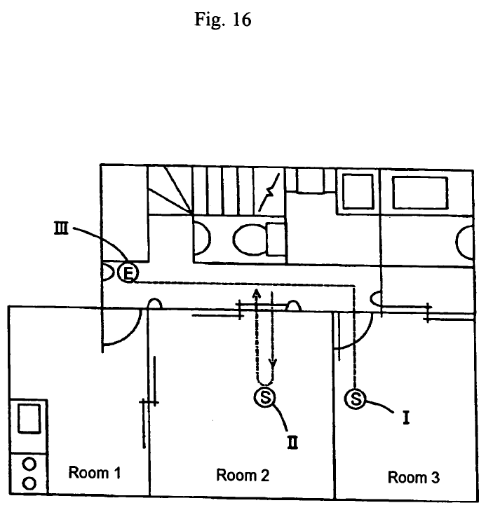

FIG. 16 shows a situation where the first guided occupant calling position I with highest priority is set in the room 3, the second guided occupant calling position II with lower priority in the room 2, and the evacuation gate III at the end of the hall.

As described above, when the self-propelled cleaner detects a fire, it travels to the room 3 where the first guided occupant calling position I with highest priority is set, and raises an alarm in step S448. If there is an response from the occupant within a predetermined period of time, the self-propelled cleaner guides the occupant to the evacuation gate III along the route shown with a dotted line. In contrast, if there is no response within the predetermined period of time and timeout occurs, the self-propelled cleaner travels along the route shown with dotted and dashed lines to the room 2 where the second guided occupant calling position II with lower priority is set, and raises an alarm in step S448. If there is a response, then the self-propelled cleaner guides the occupant to the evacuation gate III along the route shown with dashed and dotted lines, as in the case of the room 3.

If there is no response in the room 2, the self-propelled cleaner moves to the evacuation gate III and shouts the guidance message repeatedly there in step S472.

To effectively utilize the self-propelling capability, the self-propelled cleaner is made to guide the occupant from the predetermined guided occupant calling position to evacuation gate, when it detects a fire.

1. A self-propelled cleaner having a body equipped with a cleaning mechanism and a drive mechanism having a plurality of drive wheels disposed at the left and right sides of said body and capable of being controlled to rotate individually so as to enable steering and driving said cleaner, said cleaner comprising:
a mapping processor that obtains and stores in memory geographical information on a room to be cleaned while said cleaner is traveling in the room for cleaning and also obtains positional information from a marker installed at a predetermined location in the room and outputting predetermined positional information, and then adds said positional information to said geographical information;
a fire detector capable of detecting a fire in said room;
a guidance processor that allows setting a plurality of guided occupant calling positions with priority assigned, pinpointing the location of a fire, when said fire detector detected a fire, by consulting the geographical information stored in said mapping processor, and outputting a travel route from said guided occupant calling position to the evacuation gate, circumventing said location of the fire;
a communicator that provides the occupant with the information about guidance as an alarm;
an occupant reaction detector that acquires an reaction of the occupant; and
a guide travel control processor that, when said fire detector detected a fire, moves the self-propelled cleaner to said guided occupant calling position and causes said communicator to inform the occupant of the fire, and at the same time moves the self-propelled cleaner from said guided occupant calling position to the evacuation gate along the travel route obtained from said guidance processor, wherein if no reaction is available from said occupant reaction detector at said guided occupant calling position, the self-propelled cleaner travels to the next guided occupant calling position and informs the occupant of the fire.

2. A self-propelled cleaner having a body equipped with a cleaning mechanism and a drive mechanism capable of steering and driving said cleaner, said cleaner further comprising:
a mapping processor that stores in memory geographical information on a room to be cleaned;
a guidance processor that allows setting of a guided occupant calling position and an evacuation gate in said geographical information, and outputting a travel route between said guided occupant calling position and said evacuation gate;
a fire detector capable of detecting a fire in said room;
a communicator that informs the occupant of guidance information as an alarm; and
a guide travel control processor that, when said fire detector detected a fire, moves the self-propelled cleaner from the guided occupant calling position to the evacuation gate along a route obtained from said guidance processor, while causing said communicator to inform the occupant of the fire.

3. A self-propelled cleaner of claim 2, wherein
said mapping processor obtains positional information from a marker, which is installed at a predetermined location and outputs said predetermined positional information, and adds that information to said geographical information.

4. A self-propelled cleaner of claim 2 further comprising an occupant reaction detector, wherein said guide travel control processor does not start a guidance until a reaction the occupant is available from said occupant reaction detector.

5. A self-propelled cleaner of claim 4 further comprising a camera device to take surrounding images and a wireless transmitter to transmit image data to the outside wirelessly, wherein said guide travel control processor takes surrounding images and transmits the image data wirelessly to the outside via said wireless transmitter, if no reaction is available from said occupant reaction detector.

6. A self-propelled cleaner of claim 4, wherein the self-propelled cleaner moves to said evacuation gate if no reaction is available from said occupant reaction detector, and causes said communicator to inform the occupant of the location of the evacuation gate at said evacuation gate.

7. A self-propelled cleaner of claim 4, wherein said guidance processor stores a plurality of said guided occupant calling positions with priority assigned, and said guide travel control processor moves the self-propelled cleaner to the next guided occupant calling position to inform the occupant of the fire, if no reaction is available from said occupant reaction detector.

8. A self-propelled cleaner of claim 2, wherein said guidance processor can pinpoint the location of a fire, when said fire detector detected the fire, by consulting the geographical information stored in said mapping processor, and output a travel route from the guided occupant calling position to the evacuation gate, circumventing said location of the fire.
